(19) United States
(12) Patent Application Publication
(10) Pub. No.: US 2012/0287759 A1
(43) Pub. Date: Nov. 15, 2012

(54) STEPPING MOTOR CONTROL CIRCUIT AND ANALOGUE ELECTRONIC TIMEPIECE

(76) Inventor: Saburo MANAKA, Chiba-shi (JP)

(21) Appl. No.: 13/466,744

(22) Filed: May 8, 2012

(30) Foreign Application Priority Data
May 9, 2011 (JP) 2011-104521

(51) Int. Cl. G04C 3/14; H02P 8/10

(52) U.S. Cl. 368/80; 318/696

(57) ABSTRACT

A reverse rotation drive pulse includes a first pulse and a second pulse continuing from the first drive pulse and having a polarity opposite from that of the first drive pulse, a rotor is driven in the normal direction by the first pulse so that an axis of magnetic pole of the rotor rotates in the normal direction to a position beyond a notched potion nearest in the same direction, and then in the reverse direction by the second pulse to a position at which the same moves beyond the stable static position, and in the first segment and the second segment, a braking force with respect to the rotor is inhibited by connecting the detecting resistance of the coil in series and also the detection of rotation is performed.

### BACKGROUND OF THE INVENTION

1. Field of the Invention

The present invention relates to a stepping motor control circuit and an analogue electronic timepiece using the stepping motor control circuit.

2. Description of the Related Art

In the related art, a stepping motor including a stator having a rotor storage hole and a plurality of positioning portions configured to determine a stable static position of a rotor, the rotor disposed in the rotor storage hole, and a coil wound around the stator is used in analogue electronic timepieces or the like.

When driving the stepping motor to rotate, the rotor is rotated by driving the coil alternately with drive pulses having different polarities to cause a magnetic flux to be generated in the stator and is rotated by 180 degrees so as to rest at the stable static position where an axis of magnetic pole of the rotor is most apart from the positioning portion.

When rotating the rotor in the normal direction, the rotor is driven by substantially one drive pulse (single square wave pulse or a set of the drive pulses including a plurality of comb-tooth shaped pulses having the same polarity) for each polarity.

In contrast, when rotating the rotor in the reverse direction, the rotor is rotated in the reverse direction using one reverse rotation drive pulse including three pulses having different polarities (for example, see JP-A-55-33642).

FIG. 6B is a chart showing drive timings when rotating the stepping motor of the related art described in JP-A-55-33642 in the reverse direction.

In FIG. 6B, a reverse drive pulse Pgj includes a first pulse P1j, a second pulse P2j having an opposite polarity from the first pulse, and a third pulse P3j having an opposite polarity from the second pulse (the same polarity as the first pulse P1j). The first pulse P1j to the third pulse P3j are temporary continuous pulses. Provided immediately after the termination of the third pulse P3j is a detection segment Tj which is a segment in which the rotation of the stepping motor is detected.

Hereinafter, the operation for rotating the stepping motor in the reverse direction by the reverse rotation drive pulse Pgj will be described. Since the configuration of the stepping motor is the same as the stepping motor used in the present application, a stepping motor 105 in FIG. 2 to FIG. 4 as explanatory drawings the present application is used for description.

In FIG. 2, an axis of magnetic pole A of a rotor 202 rests at a stable static position (position at an angle θ0) most apart from inner notches 204 and 205 for determining the stable static position of the rotor 202 as an initial state.

When driving the rotor 202 in the reverse direction (clockwise direction) to rotate (in the reverse direction) from this state, first of all, by supplying the pulse P1j in FIG. 6B to a first terminal OUT1 and a second terminal OUT2 and driving a coil 209, an exciting current is passed through the coil 209, thereby generating a magnetic flux in the direction of an arrow in a stator 201. Accordingly, the rotor 202 is caused to rotate (normal rotation) in the normal direction (counterclockwise direction) so that the axis of magnetic pole A comes to a position immediately before the inner notch 205 due to an repulsive force between the magnetic flux of the stator 201 and the magnetic pole of the rotor 202.

Subsequently, the pulse P2j is applied to the terminals OUT1 and OUT2 to rotate the rotor 202 in the reverse direction by an attractive force between the magnetic flux of the stator 201 and the magnetic pole of the rotor 202 so that the axis of magnetic pole A comes to a position beyond the direction in which the magnetic flux is generated in the stator 201 (direction of horizontal magnetic pole: X axis).

Subsequently, the pulse P3j is applied to the terminals OUT1 and OUT2 to further rotate the rotor 202 in the reverse direction so that the axis of magnetic pole A comes to a position beyond the inner notch 204 by an repulsive force between the magnetic flux of the stator 201 and the magnetic pole of the rotor 202. After the axis of magnetic pole A has reached a perpendicular direction (the direction orthogonal to an X-axis), the rotor 202 is braked by attraction between the magnetic pole of the stator 201 and the rotor 202, and is stably rests at a position where the axis of magnetic pole A is located at an angle of θ1. Accordingly, the reverse operation at 180 degrees is completed.

For reference, a detection segment Tj in which the state of rotation of the rotor 202 is detected is provided immediately after the termination of driving by the pulse P3j, an induced signal VRs generated by the rotation of the rotor 202 in the detection segment Tj is detected, and whether or not the rotor 202 is rotated is determined depending on whether or not the induced signal VRs exceeds a predetermined reference voltage. On the basis of the result of determination whether or not the rotor is rotated, pulse control is performed, for example, by changing the pulse to a pulse having a large energy for driving.

In the next operation of reverse rotation, the drive using the reverse rotation drive pulse Pgj having the opposite polarity from the reverse rotation drive pulse Pgj is performed. Accordingly, the axis of magnetic pole A is rotated in the reverse direction to the position at an angle of θ0 in FIG. 2 to FIG. 4 and brought into rest. By driving to rotate in the reverse direction alternately by the reverse rotation drive pulse having different polarities in this manner, the operations of the reverse rotation by 180 degrees are continuously performed.

Although the reverse operation is possible in the method described above, since the reverse rotation drive pulse Pgj includes the three pulses P1j, P2j, and P3j, the total pulse length of the reverse rotation drive pulse Pgj is increased, and hence driving at a short cycle (high-speed driving) is not achieved. Therefore, in the case of the analogue electronic timepiece, there is a problem that a high-speed needle movement is not achieved. There is also a problem that the driving term is long, and hence the power consumption is increased. There is also a problem that since the braking is applied by the pulse P3j, the reverse rotation is not achieved easily.

### SUMMARY OF THE INVENTION

It is an aspect of the present application to enable a high-speed reverse-rotation driving.

Also, it is another aspect of the present application to facilitate the reverse rotation by avoiding unnecessary braking.

According to the application, there is provided a stepping motor control circuit configured to control a stepping motor, the stepping motor having: a stator including a rotor storage hole and a plurality of positioning portions configured to determine a stable static position of a rotor; the rotor disposed within the rotor storage hole; and a coil wound around the stator, the stepping motor control circuit including: a control unit configured to rotate the rotor by driving the coil by a drive pulse according to the state of rotation of the rotor and drive the rotor to rotate so that an axis of magnetic pole rests at the stable static position at a position most apart from the plurality of positioning portion; and a rotation detecting unit configured to detect the state of rotation of the rotor on the basis of an induced signal generated by the rotation of the rotor in a detection segment provided immediately after the driving by the drive pulse, wherein the drive pulse includes a first pulse and a second pulse continuing from the first pulse having a polarity opposite from that of the first pulse in the case of a reverse rotation drive pulse which causes the rotor to rotate in a predetermined direction of reverse rotation, the control unit drives the rotor in a normal direction by the first pulse so that the axis of magnetic pole of the rotor rotates in the direction of the normal rotation to a position beyond the positioning portion nearest in the direction of a normal rotation, and then drives the rotor to rotate in the reverse direction by the second pulse to a position at which the axis of magnetic pole moves beyond the stable static position, and the rotation detecting unit is configured to inhibit a braking force for the rotor by connecting the coil to a detection resistance in series and detect the state of rotation of the rotor on the basis of the induced signal generated in the detection resistance by the rotation of the rotor in the detection segment provided immediately after the driving by the second pulse.

According to the application, there is provided the analogue electronic watch having a stepping motor configured to rotate the time-of-day hands, and a stepping motor control circuit configured to control the stepping motor, characterized in that the stepping motor control circuit described above is employed as the stepping motor control circuit.

According to the stepping motor control circuit in the application, a high-speed reverse-rotation driving of the stepping motor is achieved. Also, since the unnecessary braking is not applied, the reverse rotation is advantageously facilitated.

According to the analogue electronic watch in the application, driving of the high-speed reverse-rotation needle movement is enabled. Furthermore, since the unnecessary braking in not applied, the reverse needle movement is advantageously facilitated.

### BRIEF DESCRIPTION OF THE DRAWINGS

FIG. 1 is a block diagram of an analogue electronic timepiece according to an embodiment of the invention;

FIG. 2 is an explanatory drawing showing an operation of a stepping motor used in the analogue electronic timepiece according to the embodiment of the invention;

FIG. 3 is an explanatory drawing showing the operation of the stepping motor used in the analogue electronic timepiece according to the embodiment of the invention;

FIG. 4 is an explanatory drawing showing the operation of the stepping motor used in the analogue electronic timepiece according to the embodiment of the invention;

FIG. 5 is a partly detailed circuit drawing showing a stepping motor control circuit and the analogue electronic timepiece according to the embodiment of the invention;

FIGS. 6A and 6B are drive waveform charts showing the stepping motor control circuit and the analogue electronic timepiece according to the embodiment of the invention and of the related art;

FIG. 7 is a timing chart showing the stepping motor control circuit and the analogue electronic timepiece according to the embodiment of the invention; and

FIG. 8 is a determination chart for explaining supposed operations of the stepping motor control circuit and the analogue electronic timepiece according to the embodiment of the invention.

### DESCRIPTION OF THE PREFERRED EMBODIMENTS

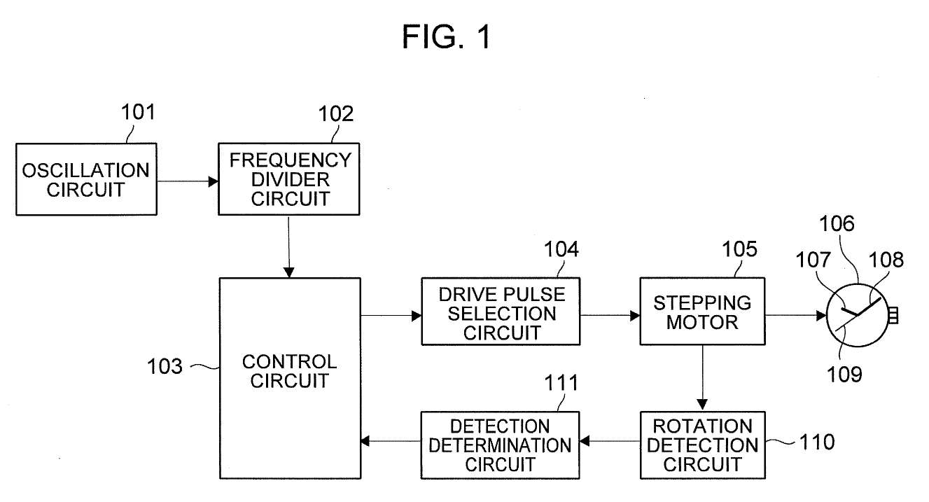

FIG. 1 is a block diagram of an analogue electronic timepiece using a stepping motor control circuit according to an embodiment of the invention, and shows an example of an analogue electronic wrist watch. In the respective drawings, the same components are designated by the same reference symbols.

In FIG. 1, the analogue electronic timepiece includes an oscillation circuit 101 configured to generate signals of a predetermined frequency, a frequency divider circuit 102 configured to divide the frequency of the signals generated by the oscillation circuit 101 and generate a clock signal which serves as a reference when counting the time, a control circuit 103 configured to perform various types of control such as control of respective electronic circuit elements which constitute the electronic timepiece and pulse control such as drive pulse change, a drive pulse selection circuit 104 configured to select and output a drive pulse for driving the rotation of a motor on the basis of a control signal from the control circuit 103, a stepping motor 105 configured to be driven to rotate by the drive pulse from the drive pulse selection circuit 104, and an analogue display unit 106 configured to be driven to rotate by the stepping motor 105 includes time-of-day hands indicating the time of day (three types; namely, an hour hand 107, a minute hand 108, and a second hand 109 in an example shown in FIG. 1).

The analogue electronic timepiece also includes a rotation detection circuit 110 configured to detect induced signal VRs which exceed a predetermined reference threshold voltage Vcomp from among induced signals VRs generated by the rotary free oscillation of the stepping motor 105 in a predetermined detection segment, and a detection determination circuit 111 configured to compare a time and a segment where the rotation detection circuit 110 detects the induced signal VRs exceeding the reference threshold voltage Vcomp and determine the segment where the induced signal VRs is detected.

The frequency divider circuit 102 divides the signal at the predetermined frequency from the oscillation circuit 101 and outputs a clock signal as a reference of time count. The control circuit 103 performs time count of the present time on the basis of the clock signal, and outputs the control signal to the drive pulse selecting circuit 104 at a predetermined cycle. The drive pulse selection circuit 104 drives the stepping motor 105 to rotate with the drive pulse corresponding to the control signal in response to the control signal from the control circuit 103.

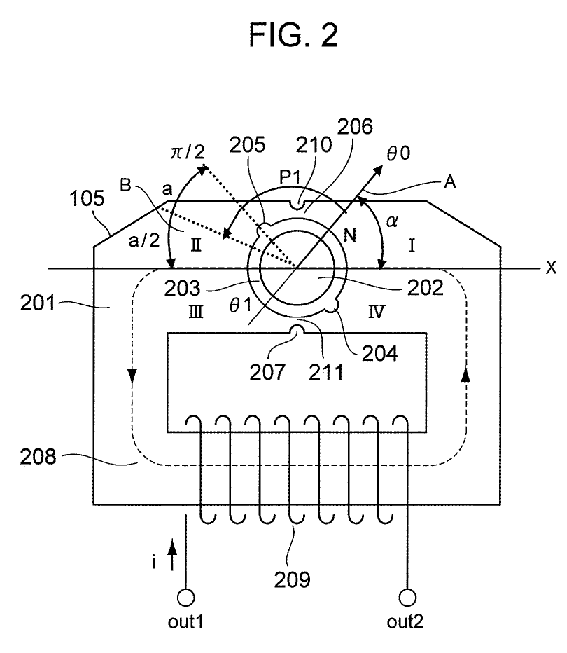

FIGS. 2 to 4 are explanatory drawings showing an operation of the stepping motor 105 in this embodiment. The stepping motor 105 by itself has a known configuration used for timepieces.

In FIGS. 2 to 4, the stepping motor 105 includes a stator 201 having a rotor storage through hole 203 as a rotor storage hole, a rotor 202 disposed in the rotor storage through hole 203 so as to be capable of rotating therein, a magnetic core 208 joined to the stator 201, and a coil 209 wound around the magnetic core 208. When the stepping motor 105 is used in the analogue electronic watch, the stator 201 and the magnetic core 208 are fixed to a base panel (not shown) with screws (not shown) and are joined to each other. The coil 201 has a first terminal OUT1 and a second terminal OUT2.

The rotor 202 is magnetized in two polarities (S-polar and N-polar). A plurality of (two in this embodiment) notched portions (outer notches) 206 and 207 are provided on outer end portions of the stator 201 formed of a magnetic material at positions opposing to each other with the intermediary of the rotor storage through hole 203. Provided between the respective outer notches 206 and 207 and the rotor storage through hole 203 are saturable portions 210 and 211.

The saturable portions 210 and 211 are configured not to be magnetically saturated by a magnetic flux of the rotor 202 and to be magnetically saturated when the coil 209 is excited so that the magnetic resistance is increased. The rotor storage through hole 203 is formed into a circular hole shape having a plurality of (two in this embodiment) semicircular notched portions (inner notches) 204 and 205 integrally formed at opposed portions of through hole having a circular contour.

The notched portions 204 and 205 constitute positioning portions for causing the rotor 202 to stably stops (stable static position). In a state in which the coil 209 is not excited, the rotor 202 stably rests at a position corresponding to the above-described positioning portions, that is, at the stable static position where an axis of magnetic pole A of the rotor 202 is most apart from the notched portions 204 and 205, in other words, at a position (position at an angle of θ0) where an axis of magnetic pole A of the rotor 202 extends orthogonally to a segment connecting the notched portions 204 and 205 as shown in FIGS. 2 to 4. An XY coordinate space extending around an axis of rotation (center of rotation) of the rotor 202 as a center is divided into four quadrants (first to fourth quadrants I to IV).

When the drive pulse selection circuit 104 supplies a square-wave normal rotation drive pulse having one of the polarities to between the terminals OUT1 and OUT2 of the coil 209 (for example, the first terminal OUT1 side is the positive pole and the second terminal OUT2 side is the negative pole), and allows a current i to flow in the direction indicated by an arrow in FIGS. 2 to 4, a magnetic flux in the direction of an arrow of a broken line is generated in the stator 201.

Accordingly, the saturable portions 210 and 211 are saturated and the magnetic resistance is increased, and then the rotor 202 rotates in a direction indicated by the arrow in FIG. 2 by 180° by a mutual action between a magnetic pole generated in the stator 201 and a magnetic pole of the rotor 202, and the axis of magnetic pole A stably stops at the stable static position at an angle of θ1. The direction of rotation (counterclockwise direction in FIGS. 2 to 4) for causing the stepping motor 105 to drive to rotate and put the same into a normal operation (the needle movement, because the watch in this embodiment is the analogue electronic watch) is defined to be a normal direction and the direction opposite therefrom (clockwise direction) is defined to be a reverse direction.

Subsequently, when the drive pulse selection circuit 104 supplies square-wave normal rotation drive pulses to the terminals OUT1 and OUT2 of the coil 209 (the first terminal OUT1 side is the negative pole and the second terminal OUT2 side is the positive pole, so that the polarity is inverted from the driving described above), and allows a current to flow in the direction opposite from that indicated by the arrow in FIGS. 2 to 4, the magnetic flux is generated in the stator 201 in the opposite direction from that indicated by the arrow of the broken line. Accordingly, the saturable portions 210 and 211 are saturated first, and then the rotor 202 rotates in the same direction as that described above by 180° by the mutual action between the magnetic pole generated in the stator 201 and the magnetic pole of the rotor 202, and the axis of magnetic pole A stably rests at the stable static position at an angle θ0.

In this manner, by supplying the signals having different polarities (alternating signals) to the coil 209 from then onward, the operation is repeatedly performed, so that the rotor 202 is configured to be capable of rotating continuously in the normal direction indicated by the arrow by 180° each. By driving the stepping motor 105 to rotate in the normal direction, the time-of-day hands 107 to 109 of the analogue display unit 106 are driven in the normal direction and the current time is displayed as needed.

In contrast, when the rotor 202 is rotated in the reverse direction (rotated in the clockwise direction), although it will be described in detail later, a reverse rotation drive pulse Pg is supplied to the terminals OUT1 and OUT2 to drive the rotor 202. Subsequently, in order to rotate the rotor 202 in the reverse direction, the reverse rotation drive pulse Pg having a polarity opposite from the reverse rotation drive pulse Pg supplied immediately before is supplied to the terminals OUT1 and OUT2 to drive the rotor 202. From then onward, by repeating this, the reverse rotation drive is performed continuously.

By driving the stepping motor 105 to rotate in the reverse direction, the time-of-day hands 107 to 109 of the analogue display unit 106 may be caused to perform operations such as driving the time-of-day hands 107 to 109 to rotate in the reverse direction and return back to zero on the hour.

Whether or not the stepping motor 105 is rotated by the rotational drive is detected in a detection segment T provided immediately after the driving by the drive pulse. The detection segment T is set to one segment at the time of driving of normal rotation, and is divided into two segments as described later at the time of driving in the reverse rotation. The detection segment T at the time of driving in the normal rotation may be divided into a plurality of segments for detection.

The rotation detection circuit 110 detects the induced signal VRs exceeding the reference threshold voltage Vcomp generated by the free oscillations of the stepping motor 105 immediately after the drive of the stepping motor 105, and the detection determination circuit 111 determines which segments of the detection segment the induced signal VRs belongs to at the time of reverse rotation.

The detection determination circuit 111 determines whether or not the rotation detection circuit 110 detects the induced signal VRs exceeding the reference threshold voltage Vcomp in the detection segment T at the time of driving in the normal rotation, and outputs a signal indicating the result of determination (“1” if the induced signal VRs exceeding the reference threshold voltage Vcomp is detected in the detection segment T, and “0” if not) to the control circuit 103. The detection determination circuit 111 does not perform the determination of the segment where the induced signal VRs exceeding the reference threshold voltage Vcomp is generated at the time of normal rotation.

Also, at the time of driving of the reverse direction, the detection determination circuit 111 determines in which one of the segments between segments T1 and T2 the rotation detection circuit 110 detects the induced signal VRs exceeding the reference threshold voltage Vcomp is determined, and outputs a signal indicating the result of determination (“1” if the induced signal VRs exceeding the reference threshold voltage Vcomp is detected in the segments T1 and T2 and “0” if not) to the control circuit 103.

The control circuit 103 determines the state of rotation such as whether or not the stepping motor 105 has rotated on the basis of the results of detection obtained by the rotation detection circuit 110 and the detection determination circuit 111, outputs the control signal to the drive pulse selecting circuit 104 according to the results of determination, and performs pulse control such as controlling the drive pulse selecting circuit 104 so as to drive the stepping motor 105 with a drive pulse having a larger energy. The drive pulse selection circuit 104 drives the stepping motor 105 to rotate with the drive pulse corresponding to the control signal.

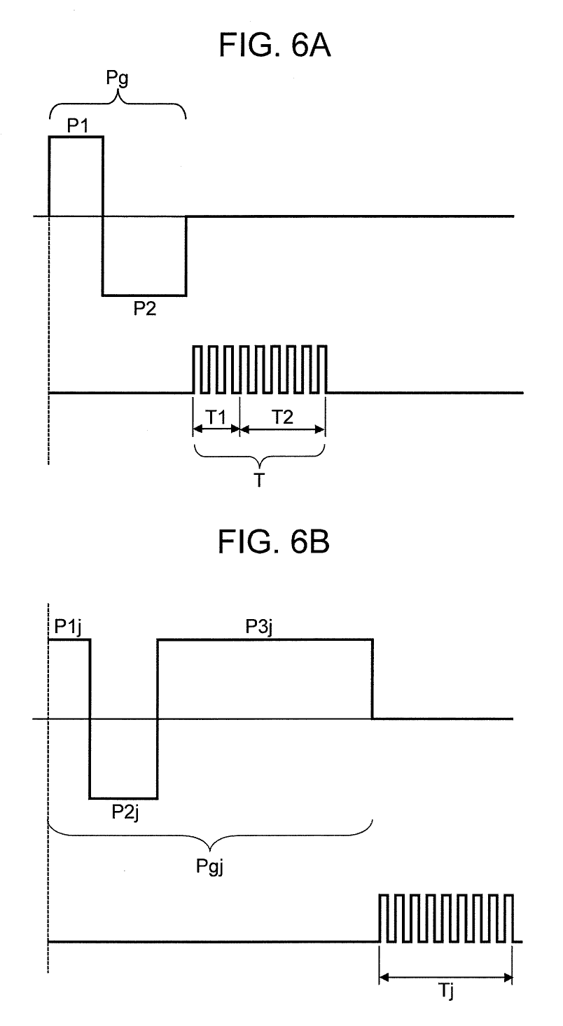

FIG. 6A is a drive waveform chart at the time of drive in the reverse direction according to this embodiment. In FIG. 6A, the reverse drive pulse Pg for driving the rotor 202 in the reverse direction includes a first pulse P1 and a second pulse P2 continuing from the first pulse P1 and having the opposite polarity form the first pulse P1. Provided immediately after the termination of the second pulse P2 is the detection segment T for detecting whether or not the rotor 202 is rotated in the reverse direction. The detection segment T is divided into the two segments (the first segment T1 having a predetermined time width and the second segment T2 provided continuously from the termination of the first segment T1.

Although the widths of the pulses P1 and P2 in FIGS. 6A and 6B are different, the lengths of the detection segment T are the same in FIGS. 6A and 6B. Therefore, the reverse rotation drive pulse Pg used in the first embodiment is a drive pulse having a shorter time width than a reverse rotation drive pulse Pgj of the related art.

When the stepping motor 105 is driven in the reverse direction, the control circuit 103 outputs the control signal to cause the stepping motor 105 to be driven by the reverse rotation drive pulse Pg configured by the two pulses (the first pulse P1 and the second pulse P2) shown in FIG. 6A. In this case, the drive pulse selecting circuit 104 drives the stepping motor 105 firstly by the first pulse P1, and then, drives the stepping motor 105 by the second pulse P2. The total time width of the first pulse P1 and the second pulse P2 is configured to be smaller than the sum of the time widths of pulses P1j to P3j which constitute the reverse rotation drive pulse Pgj in FIG. 6B. Accordingly, high-speed drive and reduction of consumption power are enabled.

After the drive pulse selecting circuit 104 has driven the stepping motor 105 in the reverse rotation using the reverse rotation drive pulse Pg in FIG. 6A in response to the control signal, the rotation detection circuit 110 performs a rotation detecting operation in the detection segment T provided immediately after the termination of the driving in the reverse direction, and the detection determination circuit 111 determines whether or not the induced signal exceeding the reference threshold voltage Vcomp has detected in the two segments T1 and T2.

The control circuit 103 determines the state of rotation of the stepping motor 105 on the basis of the pattern of the induced signal VRs (the decision value in the first segment T1 and the decision value in the second segment T2) detected in the respective segments T1 and T2.

When it is determined that the stepping motor 105 has not rotated on the basis of the result of determination by the detection determination circuit 111, the control circuit 103 forcedly drives the stepping motor to rotate by the reverse rotation drive pulse Pg obtained by increasing the width of the first pulse P1 or the second pulse P2 (having larger energy).

The oscillation circuit 101 and the frequency divider circuit 102 constitute a signal generating unit, the analogue display unit 106 constitutes a time display unit, and the rotation detection circuit 110 constitutes a rotation detecting unit. The control circuit 103, the drive pulse selection circuit 104, and the detection determination circuit 111 constitute a control unit.

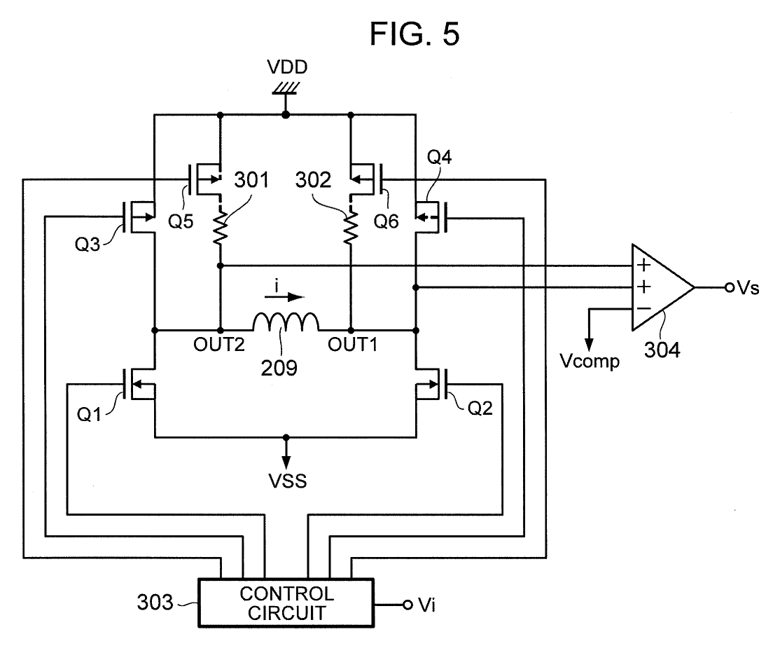

FIG. 5 is a partly detailed circuit drawing of the stepping motor control circuit and the analogue electronic timepiece according to this embodiment, and is a partly detailed circuit drawing of the drive pulse selection circuit 104 and the rotation detection circuit 110.

At the time of driving in the normal rotation or at the time of driving in the reverse rotation, a switch control circuit 303 supplies a current to the coil 209 in the normal direction or in the reverse direction by controlling transistors Q2 and Q3 to an ON state simultaneously or controlling transistors Q1 and Q4 to an ON state simultaneously in response to a control signal Vi supplied from the control circuit 103, thereby driving to rotate the stepping motor 105. When the rotation is detected, the transistors Q3 to Q3 are controlled to one of the ON state, the OFF state, and a switching state to generate the induced signal VRs in detection resistance 301 or 312.

The transistors Q1 and Q2 are components of the drive pulse selection circuit 104, and the transistors Q5 and Q6 and the detection resistances 301 and 302 are components of the rotation detection circuit 110. Also, the transistors Q3 and Q4 are components used both in the drive pulse selection circuit 104 and the rotation detection circuit 110. The detection resistances 301 and 302 are elements having the same resistance value, and constitute a detection element.

When driving the stepping motor 105 to rotate in the normal direction, the drive current i in the direction of the arrow is supplied to the coil 209 of the stepping motor 105 by driving the transistors Q2 and Q3 into the ON state by a normal rotation main drive pulse. Accordingly, when the stepping motor 105 is rotated, the rotor 202 rotates by 180 degrees in the normal direction.

The rotation detection circuit 110 detects the induced signal VRs generated in the detection resistance 302 by switching the transistor Q4 in a state of turning the transistors Q3 and Q6 ON by the switch control circuit 303 in the detection segment T immediately after the driving using the normal rotation main drive pulse. The comparator 304 compares the induced signal VRs and the predetermined reference threshold voltage Vcomp and outputs a detecting signal Vs which indicates whether or not the induced signal VRs exceeds the reference threshold voltage Vcomp to the detection determination circuit 111.

The reference threshold voltage Vcomp is set so that the induced signal VRs exceeding the reference threshold voltage Vcomp is generated when the stepping motor 105 rotates in the normal direction, and the induced signal VRs exceeding the reference threshold voltage Vcomp is not generated when the stepping motor 105 cannot be rotated in the normal direction.

The detection determination circuit 111 at the time of normal rotation determines whether or not the rotation detection circuit 110 detects the induced signal VRs exceeding the reference threshold voltage Vcomp in the detection segment T, and outputs a signal indicating the result of determination (“1” if the induced signal VRs exceeding the reference threshold voltage Vcomp is detected within the detection segment T, and “0” if not) to the control circuit 103.

When it is determined that the stepping motor 105 has not rotated on the basis of the result of determination by the detection determination circuit 111, the control circuit 103 drives the stepping motor 105 with a correction drive pulse having a larger energy than the normal rotation main drive pulse to forcedly rotate the stepping motor 105.

When driving the stepping motor 105 in the reverse rotation, although it will be described in detail later, the stepping motor 105 is driven by the reverse rotation drive pulse Pg configured by the pulses P1 and P2 and, immediately thereafter, the rotation detecting operation is performed. The control circuit 103 determines the state of rotation of the stepping motor 105 on the basis of the pattern of the induced signal VRs (the determined value in the first segment and the decision value of the second segment) detected in the two segments T1 and T2.

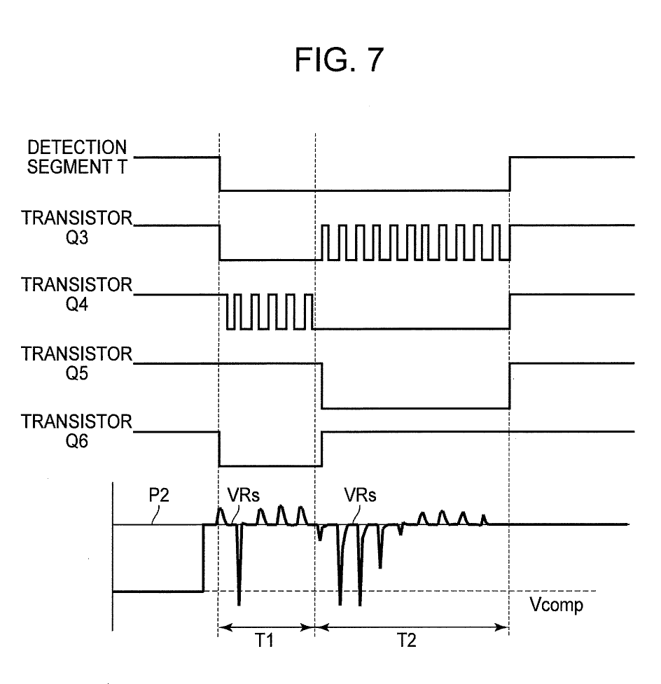

FIG. 7 is a timing chart at the time of driving in the reverse rotation in this embodiment.

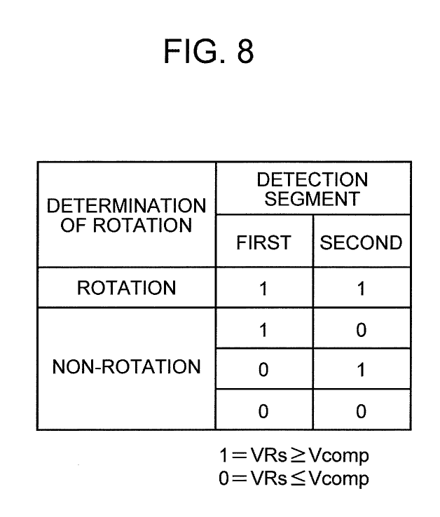

FIG. 8 is a determination chart for determining the state of rotation at the time of driving in the reverse direction in this embodiment.

The operations of the stepping motor control circuit and the analogue electronic watch according to the embodiment of the invention configured as described above will be described in detail.

The driving operation in the normal rotation of the stepping motor 105 is the same as those of the related art and the outline of the operation is described above, so that the driving operation in the reverse rotation, which is a characteristic point of this embodiment, will be described in detail.

When the control signal Vi for driving the stepping motor 105 in the reverse rotation is input to the drive pulse selection circuit 104 from the control circuit 103, the drive pulse selection circuit 104 drives the stepping motor 105 to rotate by the reverse rotation drive pulse Pg in response to the control signal Vi.

The following description is based on the assumption that the rotor 202 is at the stable static position shown in a state in FIG. 2 (the position where the axis of magnetic pole A is located at a position most apart from the plurality of nearest notched portions 205) θ0 as an initial state.

The switch control circuit 303 firstly drives the axis of magnetic pole A to a position between the notched portion 205 at a position nearest in the direction of normal rotation (in FIG. 2, the angle with respect to the direction of the horizontal magnetic pole (direction of an X-axis) is “a” (in the example shown in FIG. 2, a is equal to π/2)) and a position B at half an angle between the notched portion 205 at a position nearest in the direction of normal rotation and the stator 201 by the first pulse P1 about the rotor 202 as the center. In this case, the rotor 202 is rotated in the normal direction to the above-described position by a repulsive force generated between the magnetic flux generated in the stator 201 and the magnetic pole of the rotor 202.

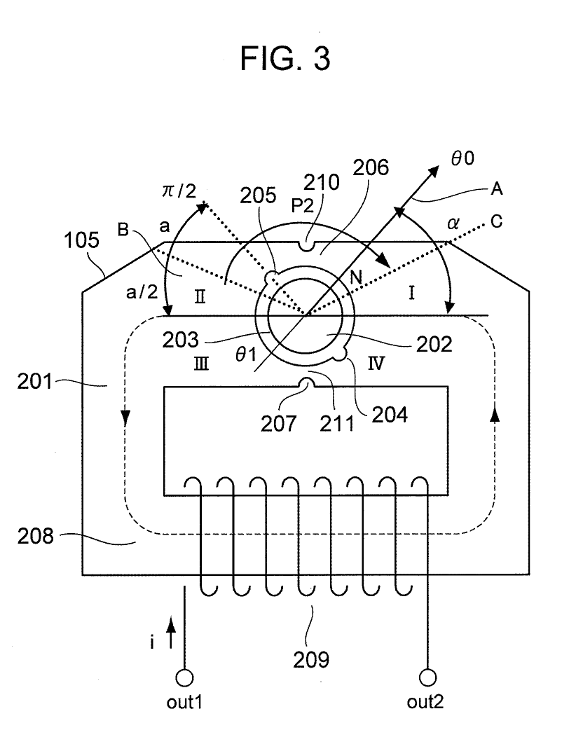

Subsequently, the switch control circuit 303 drives the axis of magnetic pole A in the reverse rotation to a position between the stable static position θ0 and a position C which is a position half an angle between the stable static position θ0 and the direction of horizontal magnetic pole by the second pulse P2 (FIG. 3). In this case, the rotor 202 is rotated in the reverse direction to the above-described position by a repulsive force generated between the magnetic flux generated in the stator 201 and the magnetic pole of the rotor 202.

In this manner, by rotating the rotor 202 at a high speed in the normal direction to a position beyond the notched portion 205, which is a point of the maximum magnetic potential by a repulsive force generated by the first pulse P1, and then rotating the rotor 202 in the reverse direction to a position beyond the stable static position θ0 by the repulsive force generated by the second pulse P2 continuing from the first pulse P1 and having a polarity opposite from the first pulse P1, the rotor 202 can be rotated at a high speed in the reverse direction to a position beyond a stable static position θ0.

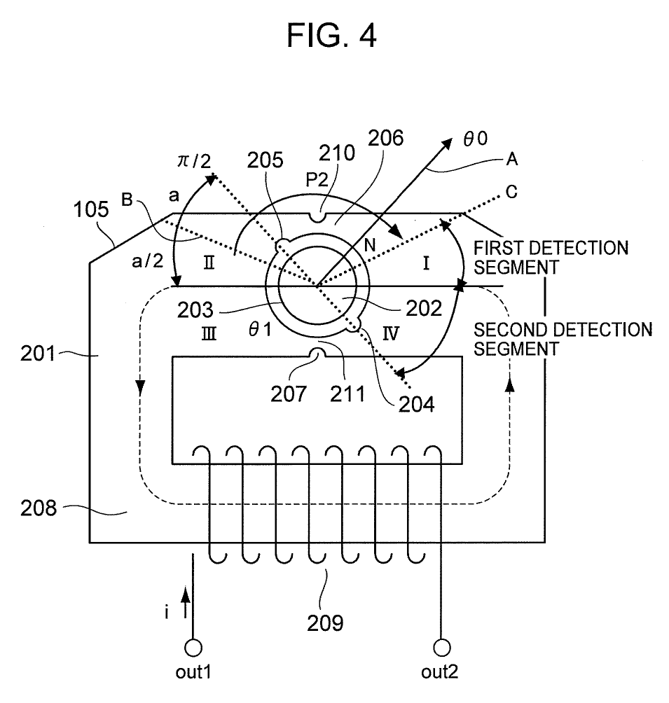

Subsequently, the switch control circuit 303 performs switching drive of the transistor Q4 in a state in which the transistors Q3 and Q6 are in the On state as shown in FIG. 7 in the first segment T1 of the detection segment T provided continuously from the termination of driving of the second pulse P2. The first segment T1 is set to a range from the position C to the direction of the horizontal magnetic pole (X-axis) as shown in FIG. 4. The first segment T1 is an area in which the rotation of the rotor 202 is detected in the first quadrant about the rotor 202.

In this state, since the detection resistance 302 is connected in series to the coil 209, the rotor 202 is not braked and hence is brought into a free state. Since a braking force with respect to the rotor 202 can be inhibited, the rotor 202 can be rotated in the reverse direction easily without being reduced in speed by braking. The induced signal VRs generated by free rotary oscillations of the rotor 202 is generated in the detection resistance 302.

In the second segment T2 continuing from the first segment T1, the switch control circuit 303 performs switching drive on the transistor Q3 in a state in which the transistors Q4 and Q5 are in the On state as shown in FIG. 7. The second segment T2 is set to a range from the direction of horizontal magnetic pole (X-axis) to the notched portion 204 which is the point of the maximum magnetic potential as shown in FIG. 4. The second segment T2 is an area in which the rotation of the rotor 202 is detected in the fourth quadrant about the rotor 202.

In this state, since the detection resistance 301 is connected in series to the coil 209, the rotor 202 is not braked and hence is brought into a free state. Therefore, the rotor 202 is not braked, the rotor 202 can be rotated easily in the reverse direction without being reduced in speed by the braking. The induced signal VRs generated by the free rotary oscillations of the rotor 202 is generated in the detection resistance 301.

In this manner, the detection segment T is provided immediately after the driving by the reverse rotation drive pulse Pg and the detection resistance 301 or 302 is connected in series to the coil 209 when the transistors Q5 and Q6 are in the On state in the detection segment T, so that the braking force applied to the rotor 202 can be inhibited. Therefore, the rotor 202 can be rotated in the reverse direction without being reduced in speed. Also, the detection periods of the first and second detection segment T1 and T2 may be reduced by switching the polarity of the induced signal VRs to be detected by switching the points of connection between the detecting resistances 301 and 302 to be connected to the coil 209.

The induced signal VRs is compared with the reference threshold voltage Vcomp by the comparator 304, and the segments T1 and T2 where the induced signal VRs exceeding the reference threshold voltage Vcomp is generated are determined by the detection determination circuit 111.

In the example shown in FIG. 7, a pattern of the induced signal VRs is (1, 1), and is a pattern obtained when the reverse rotation is normally performed. The control circuit 103 determines that the reverse rotation is normally performed when the pattern (1, 1) is obtained.

FIG. 8 is a determination chart for determining the content of the pattern of the induced signal VRs.

In FIG. 8, the pattern (1, 1) is a pattern indicating that the reverse rotation of the rotor 202 is performed normally as described above. In this case, the rotor 202 rotates in the direction of the reverse rotation normally in the first segment T1, and the axis of magnetic pole A of the rotor 202 moves beyond the direction of horizontal magnetic pole (X-axis direction) so that the operation of reverse rotation is performed normally in the second segment T2. In this manner, in the normal reverse rotation, the rotor 202 rotates at a certain speed or higher in the first and second segments T1 and T2 after having blocked the second pulse P2, so that the induced signal VRs exceeding the reference threshold voltage Vcomp can be obtained.

The cases other than the pattern (1, 1) indicate that the rotor 202 is not rotated normally in the reverse direction, and the rotor 202 inevitably returns back to its original stable static position after having driven by the reverse rotation drive pulse Pg. In a non-rotating state, a drive force of the first pulse P1 is not sufficient, an attracting state occurs after the blockage of the second pulse P2, and the lowering in speed of the first segment T1 occurs, so that the induced signal VRs exceeding the reference threshold voltage Vcomp cannot be obtained.

For example, in the case of a pattern (0, 1), the rotation in the reverse direction is achieved normally within the first segment T1. However, in the second segment T2, the rotor 202 rotates abnormally in such a manner that the axis of magnetic pole A is almost stopped near the horizontal magnetic pole or rotates slowly from the position C in the direction of the horizontal magnetic pole while generating the induced signal VRs as low as the reference threshold voltage Vcomp or less.

In the case of the pattern (0, 1), the drive force of the first pulse P1 is small in the first segment T1, and hence the axis of magnetic pole A does not reach the notched portion 205 by being driven by the first pulse P1 and the driving by the second pulse P2 is performed in this state. In this state, an attracting force acts on the rotor 202 by being driven by the second pulse P2, whereby the abnormal rotation toward the stable static position θ0 is performed. Within the second segment T2, the speed of rotation at the stable static position θ0 is increased due to the balance between the rotation near the notched portion 205 by the first pulse P1 and the attracting rotation by the second pulse P2, whereby the high induced signal VRs exceeding the reference threshold voltage Vcomp is generated. However, the generated high induced signal VRs is not enough for the reverse rotation of the rotor 202, so that the abnormal rotation is resulted.

Also, in the case of the pattern (0, 0), within the first segment T1, the drive force of the first pulse P1 is small, and hence the axis of magnetic pole A does not reach the notched portion 205 by being driven by the first pulse P1, so that the drive by the second pulse P2 is performed. In this state, the attracting force acts on the rotor 202 by being driven by the second pulse P2, whereby the abnormal rotation toward the stable static position θ0 is performed. However, the speed of rotation of the rotor 202 is low and hence the induced signal VRs does not exceed the reference threshold voltage Vcomp. Within the second segment T2, vibrations of the rotor 202 is damped and hence the induced signal VRs exceeding the reference threshold voltage Vcomp is not generated.

As described thus far, the stepping motor control circuit according to the embodiment includes a stator 201 having a plurality of notched portions 204 and 205 which determine the stable static positions θ0, θ1 of the rotor storage through hole 203 and the rotor 202, a rotor 202 disposed in the rotor storage through hole 203, and a control unit configured to rotate the rotor 202 by driving the coil 209 by a drive pulse according to the state of rotation of the rotor 202 and performs the rotational drive so as to cause the axis of magnetic pole A of the rotor 202 to rest at the stable static positions θ0, θ1 most apart from the plurality of notched portions 204 and 205, and the rotation detecting unit configured to detect the state of rotation of the rotor 202 on the basis of the induced signal VRs generated by the rotation of the rotor 202 in the detection segment T provided immediately after the driving of the drive pulse, wherein the drive pulse includes the first pulse P1 and the second pulse P2 continuing from the first pulse P1 and having a polarity opposite from the first pulse 21, in the case of the reverse rotation pulse Pg which causes the rotor 202 to rotate in a predetermined direction of reverse rotation, and the control unit drives the rotor 202 so that the axis of magnetic pole A of the rotor 202 is rotated in the normal direction by the first pulse 21 to a position beyond the notched portions 204 and 205 at positions nearest in the direction of normal rotation, and then drives the rotor 202 in the reverse rotation by the second pulse P2 until the axis of magnetic pole A moves to a position beyond the stable static positions θ0, θ1, and the rotation detecting unit inhibits the braking force applied to the rotor 202 by connecting the detecting resistances 301 and 302 with the coil 209 in series in the detection segment T provided immediately after being driven by the second pulse P2 and detects the state of rotation of the rotor 202 on the basis of the induced signal VRs generated in the detecting resistances 301 and 302 by the rotation of the rotor 202.

In this manner, the reverse rotation drive pulse Pg includes the first pulse P1 and the second pulse P2 continuing from the first pulse P1 and having the polarity opposite from the first pulse P1, and the rotor 202 is driven to rotate in the normal direction by the first pulse P1 so that the axis of magnetic pole A of the rotor 202 rotates in the normal direction to the position beyond the notched portions 204 and 205 nearest in the direction of normal rotation, and is driven to rotate in the reverse direction by the second pulse P2 so that the axis of magnetic pole A moves to the position beyond the stable static position θ0, and the detection resistance is connected to the coil 209 in series in the first segment T1 and the second segment T2, whereby the braking force with respect to the rotor 202 is inhibited and the rotation is detected.

Here, the control unit may be configured to drive the rotor 202 so that the axis of magnetic pole A is driven to a position between the notched portions 204 and 205 nearest in the direction of normal rotation and the position half an angle between the notched portions 204 and 205 nearest in the direction of normal rotation and the direction of horizontal magnetic pole generated in the stator 201 by the first pulse P1 about the rotor 202, and then drive the axis of magnetic pole A to a position between the stable static positions θ0, θ1 and a position half the angle between the stable static positions θ0, θ1 and the direction of the horizontal magnetic pole by the second pulse P2.

Also, a configuration in which the detection segment T includes the first segment T1 and the second segment T2, and the first segment T1 and the second segment T2 may be configured in such a manner that the polarity of the induced signal VRs to be detected is switched by switching the point of connection between the detecting resistances 301 and 302 to be connected to the coil 209 is also applicable.

Also, assuming that the center of the rotor 202 is an original point and the direction of horizontal magnetic pole generated in the stator 201 is an X-axis, a configuration in which the first segment T1 is a segment for detecting the rotation of the rotor 202 in the first quadrant, and the second segment T2 is a segment for detecting the rotation of the rotor 202 in the fourth quadrant is also applicable.

Also, a configuration in which the first segment T1 is a segment from the position of termination of driving by the second pulse P2 to the direction of horizontal magnetic pole, and the second segment T2 is a segment from the direction of horizontal magnetic pole to the notched portions 204 and 205 nearest in the direction of reverse rotation is applicable.

Also, the rotation detecting unit may be configured to determine that the rotor 202 is rotated in the reverse direction when the pattern of the induced signals VRs in the first segment T1 and the second segment T2 is (1, 1).

Therefore, the stepping motor 105 can be driven to rotate in the reverse direction at a high speed. Also, since unnecessary braking is not applied to the rotor 202, the reverse rotation is advantageously facilitated. Furthermore, advantages that a pulse P3 of the related art is not necessary, the driving period can be reduced, and the high-speed needle movement and the low power consumption can be supported are achieved.

According to the analogue electronic timepiece in the invention, the high-speed needle movement in the reverse direction is enabled. Furthermore, since the unnecessary braking in not applied, the reverse needle movement is advantageously facilitated.

The invention is also applicable to the stepping motor for driving a calendar or the like in addition to the time-of-day hands.

Also, although the electronic watch has been described as an example of the application of the stepping motor, it may be applicable to electronic instruments which use a motor.

### INDUSTRIAL APPLICABILITY

The stepping motor control circuit according to the invention may be applicable to various electronic instruments using the stepping motor.

The electronic timepiece according to the invention is applicable to various analogue electronic timepieces including various types of analogue electronic timepiece with a calendar function such as analogue electronic wrist watch with a calendar function and analogue electronic standing clocks with a calendar function.

What is claimed is:

1. A stepping motor control circuit configured to control a stepping motor, the stepping motor having: a stator including a rotor storage hole and a plurality of positioning portions configured to determine a stable static position of a rotor; the rotor disposed within the rotor storage hole; and a coil wound around the stator, the stepping motor control circuit comprising:
a control unit configured to rotate the rotor by driving the coil by a drive pulse according to the state of rotation of the rotor and drive the rotor to rotate so that an axis of magnetic pole of the rotor rests at the stable static position at a position most apart from the plurality of positioning portion; and
a rotation detecting unit configured to detect the state of rotation of the rotor on the basis of an induced signal generated by the rotation of the rotor in a detection segment provided immediately after the driving by the drive pulse, wherein
the drive pulse includes a first pulse and a second pulse continuing from the first pulse having a polarity opposite from that of the first pulse in the case of a reverse rotation drive pulse which causes the rotor to rotate in a predetermined direction of reverse rotation,
the control unit drives the rotor in the normal direction by the first pulse so that the axis of magnetic pole of the rotor rotates in the direction of the normal rotation to a position beyond the positioning portion nearest in the direction of a normal rotation, and then drives the rotor to rotate in the reverse direction by the second pulse to a position at which the axis of magnetic pole moves beyond the stable static position, and
the rotation detecting unit is configured to inhibit a braking force for the rotor by connecting the coil to a detection resistance in series and detect the state of rotation of the rotor on the basis of the induced signal generated in the detection resistance by the rotation of the rotor in the detection segment provided immediately after the driving by the second pulse.

2. The stepping motor control circuit according to claim 1, wherein the control unit drives the axis of magnetic pole to a position between the positioning portion nearest in the direction of the normal rotation and a position half the angle between the positioning portion nearest in the direction of the normal rotation and the direction of horizontal magnetic pole generated in the stator by the first pulse, then drives the axis of magnetic pole to a position between the stable static position and a position half the angle between the stable static position and the direction of horizontal magnetic pole by the second pulse about the rotor.

3. The stepping motor control circuit according to claim 2, wherein the detecting segment includes a first segment and a second segment, and the first segment and the second segment are configured in such a manner that the polarity of an induced signal to be detected is switched by switching the point of connection between the detecting resistances connected to the coil.

4. The stepping motor control circuit according to claim 3, wherein the first segment is a segment in which the rotation of the rotor in a first quadrant is detected and the second segment is a segment where the rotation of the rotor in a fourth quadrant is detected when assuming that the center of the rotor is an original point and the direction of horizontal magnetic pole generated in the stator is an X-axis.

5. The stepping motor control circuit according to claim 4, wherein the first segment is a segment from the position of termination of the second pulse driving to the direction of horizontal magnetic pole and the second segment is a segment from the direction of the horizontal magnetic pole to the positioning portion at a position nearest in the direction of the reverse rotation.

6. The stepping motor control circuit according to claim 3, wherein the rotation detecting unit determines that the rotor is rotated in the reverse direction when the pattern of the induced signal in the first segment and the second segment is (1, 1).

7. The stepping motor control circuit according to claim 4, wherein the rotation detecting unit determines that the rotor is rotated in the reverse direction when the pattern of the induced signal in the first segment and the second segment is (1, 1).

8. The stepping motor control circuit according to claim 5, wherein the rotation detecting unit determines that the rotor is rotated in the reverse direction when the pattern of the induced signal in the first segment and the second segment is (1, 1).

9. An analogue electronic timepiece having a stepping motor configured to drive time-of-day hands to rotate, and a stepping motor control circuit configured to control the stepping motor,
wherein the stepping motor control circuit according to claim 1 is used as the stepping motor control circuit.

10. An analogue electronic timepiece having a stepping motor configured to drive time-of-day hands to rotate, and a stepping motor control circuit configured to control the stepping motor,
wherein the stepping motor control circuit according to claim 2 is used as the stepping motor control circuit.

11. An analogue electronic timepiece having a stepping motor configured to drive time-of-day hands to rotate, and a stepping motor control circuit configured to control the stepping motor,
wherein the stepping motor control circuit according to claim 3 is used as the stepping motor control circuit.

12. An analogue electronic timepiece having a stepping motor configured to drive time-of-day hands to rotate, and a stepping motor control circuit configured to control the stepping motor,
wherein the stepping motor control circuit according to claim 4 is used as the stepping motor control circuit.

13. An analogue electronic timepiece having a stepping motor configured to drive time-of-day hands to rotate, and a stepping motor control circuit configured to control the stepping motor,
wherein the stepping motor control circuit according to claim 5 is used as the stepping motor control circuit.

14. An analogue electronic timepiece having a stepping motor configured to drive time-of-day hands to rotate, and a stepping motor control circuit configured to control the stepping motor,
wherein the stepping motor control circuit according to claim 6 is used as the stepping motor control circuit.

15. An analogue electronic timepiece having a stepping motor configured to drive time-of-day hands to rotate, and a stepping motor control circuit configured to control the stepping motor,
wherein the stepping motor control circuit according to claim 7 is used as the stepping motor control circuit.

16. An analogue electronic timepiece having a stepping motor configured to drive time-of-day hands to rotate, and a stepping motor control circuit configured to control the stepping motor,
wherein the stepping motor control circuit according to claim 8 is used as the stepping motor control circuit.
